(19) United States
(12) Patent Application Publication
(10) Pub. No.: US 2026/0331984 A1
(43) Pub. Date: Oct. 22, 2026

(54) Electric Motor

(71) Applicant: Innomotics GmbH, Nürnberg (DE)

(72) Inventor: Frank Brütting, Erlangen (DE)

(73) Assignee: Innomotics GmbH, Nürnberg (DE)

(21) Appl. No.: 18/880,862

(22) PCT Filed: Jun. 13, 2023
(86) PCT No.: PCT/EP2023/065736

§ 371 Date: Jan. 3, 2025

(30) Foreign Application Priority Data
Jul. 5, 2022 (EP) 22182975.7

(51) Int. Cl. H02K 3/28; H02K 9/22; H02K 11/33

(52) U.S. Cl. CPC H02K 3/28; H02K 9/22; H02K 11/33; H02K 2203/03

(57) ABSTRACT

Various embodiments of the teachings herein include an electric motor comprising: a stator with a plurality of field conductor bars; an inverter having one or more parallel power components for each of the field conductor bars, and a controller to generate control signals for the one or more power components; a respective plug connector arranged on each of the circuit boards to contact the output stages ; and a connector board plugged into plug connectors of circuit boards of different circular or annular structures that are azimuthally identical with respect to the central axis. Output stages of the inverter are arranged on a plurality of circuit boards. The individual circuit boards are arranged to form at least two circular or annular structures arranged parallel and axially offset with respect to one another, so respective centers lie on a common central axis.

### CROSS-REFERENCE TO RELATED APPLICATIONS

This application is a U.S. National Stage Application of International Application No. PCT/EP 2023/065736 filed Jun. 13, 2023, which designates the United States of America, and claims priority to EP Application No. 22182975.7 filed Jul. 5, 2022, the contents of which are hereby incorporated by reference in their entirety.

### TECHNICAL FIELD

The present disclosure relates to electric motors. Some embodiments of the teachings herein include electric motors having a stator-side bar winding.

### BACKGROUND

Electric motors can have a bar winding on the stator side. In this case, the stator has a series of bars in lieu of wound wire conductors as field conductors. The bars have a low inductance in comparison with conventional windings. Therefore, a comparatively high current flow is required for the generation of a predetermined magnetic field.

This high current flow requires only a comparatively low voltage of, for example, 12 V. The low voltage makes it possible to arrange the components of the inverters, with which the bars are controlled, at small distances from one another. For example, the components of the power electronics can be arranged on one or more circuit boards that are arranged close to the electric motor. Such an electric motor can be designed in a compact manner so that each of the field conductors is controlled by its own power components and thus each field conductor can be controlled with its own phase. Thus, electric motors with 48, 72 or even 120 field conductors and phases can be compactly constructed.

The problem here is that the large number of power units must be connected to a central controller. Cable connections between a central controller and a large number of power components disadvantageously result in a very complex construction.

### SUMMARY

Teachings of the present disclosure include electric motors that eliminates the above-mentioned disadvantage, in particular with a more efficient connection between the controller and the power components. For example, some embodiments include an electric motor (10) having: a stator (11) having a plurality of field conductors (12) that are designed as bars, an inverter having one or more parallel power components for each of the field conductors (12) for their control, wherein the inverter comprises a controller for generating control signals for the power components, wherein the output stages of the inverter are arranged on a plurality of circuit boards (15), the circuit boards (15) are arranged in such a manner that they form at least two circular or annular structures, the circular or annular structures are arranged parallel with respect to one another and axially offset with respect to one another, so that their centers lie on a common central axis, one or more plug connectors (33) are arranged on each of the circuit boards (15) for contacting the output stages, a connector board (32, 81, 91, 101) is plugged into plug connectors (33) of circuit boards (15) of different circular or annular structures that are azimuthally identical with respect to the central axis.

In some embodiments, the axis of the circular or annular structures corresponds to the motor axis (9).

In some embodiments, the circular or annular structures have the same diameter.

In some embodiments, the connector boards (32, 81, 91, 101) extend in the axial direction parallel to the motor axis (9).

In some embodiments, the number of connector boards (32, 81, 91, 101) corresponds to the number of field conductors (12).

In some embodiments, the connector board (32, 81, 91, 101) comprises gate driver circuits (72) for the power components.

In some embodiments, the connector board (32, 81, 91, 101) comprises a multiplexer (93) and is designed so as to conduct control signals that are incoming from the controller to one of a plurality of signal lines in such a manner that the control signals are fed to those power components to which they are addressed.

In some embodiments, the connector board (32, 81, 91, 101) comprises one or more screw connections to one or more of the circular or annular structures.

In some embodiments, the connector board (32, 81, 91, 101) is a flexible circuit board.

In some embodiments, current conductors (18) lengthen the field conductors (12) axially.

In some embodiments, the circuit boards (15) are arranged on at least one cooling plate (16).

In some embodiments, the cooling plate (16) is arranged in such a manner that the field conductors (12) or current conductors (18) that are electrically connected to the field conductors (12) are mechanically operatively connected to the cooling plate (16), in particular are designed as a mechanical carrier for the cooling plate (16).

In some embodiments, the circuit boards (15) are circular or in the form of a ring sector.

In some embodiments, the electric motor (10) controls the field conductors (12) with at least 6 phases.

In some embodiments, the inverters are designed so as to generate an AC voltage having an amplitude of 200 V or less, in particular 100 V or less, in particular 50 V or less.

### BRIEF DESCRIPTION OF THE DRAWINGS

The teachings herein are further described and explained hereinunder with the aid of the exemplary embodiments illustrated in the figures. In the drawings:

FIG. 1 shows an oblique view of an electric motor incorporating teachings of the present disclosure having power components arranged on circuit boards that are carried by cooling plates;

FIG. 2 shows a front view of circuit boards that are arranged on a cooling plate incorporating teachings of the present disclosure;

FIG. 3 shows a section of the electric motor in an oblique view with cooling plates having circuit boards incorporating teachings of the present disclosure;

FIG. 4 shows a side view of a section of the electric motor with cooling plates having circuit boards and connector boards plugged in via spring contacts incorporating teachings of the present disclosure;

FIG. 5 shows a front view of the electric motor incorporating teachings of the present disclosure with cooling plates having circuit boards and connector boards;

FIG. 6 shows a second diagram for the spring contacts as a connection between connector boards and circuit boards incorporating teachings of the present disclosure;

FIG. 7 shows a construction having gate driver circuits on driver boards incorporating teachings of the present disclosure;

FIG. 8 shows a first embodiment for the connector boards incorporating teachings of the present disclosure;

FIG. 9 shows a second embodiment for the connector boards incorporating teachings of the present disclosure;

FIG. 10 shows a third embodiment for the connector boards having gate driver circuits incorporating teachings of the present disclosure; and

FIG. 11 shows a construction having additional second connector boards incorporating teachings of the present disclosure.

### DETAILED DESCRIPTION

An example electric motor incorporating teachings of the present disclosure comprises a stator having a plurality of field conductors that are designed as bars. Furthermore, the electric motor comprises an inverter having one or more parallel power components for each of the field conductors for their control, wherein the inverter comprises a controller for generating control signals for the power components.

In this case, the output stages of the inverter are arranged on a plurality of circuit boards. The circuit boards are in turn arranged in such a manner that they form at least two circular or annular structures. The circular or annular structures are arranged parallel with respect to one another and axially offset with respect to one another, so that their centers lie on a common central axis.

One or more plug connectors are arranged on each of the circuit boards for contacting the output stages. A connector board is plugged into plug connectors of circuit boards of different circular or annular structures that are azimuthally identical with respect to the central axis.

In relation to the circular or annular structures, parallel means that their circular or annular planes are parallel or expressed mathematically in another manner, that their surface normals have the same direction.

Axially offset in relation to the circular or annular structures means that they are (exclusively) displaced in relation to one another along a matching axis, wherein this axis corresponds to the central axis, that is to say the surface normal through the circular or annular center point.

Since the circular or annular structures are constructed from a plurality of circuit boards, it is understood that they are not geometrically exact and the circular or annular surface also does not have to be completely filled. Rather, gaps remain between the circuit boards.

If polar coordinates are placed in each of the circular or annular structures, then azimuthal denotes the angle in these polar coordinates. Azimuthally identical plug connectors are thus in the same direction from the central axis. Such plug connectors of different circular or annular structures thus form a line that is parallel to the central axis.

The plug connectors can be, for example, spring contacts or direct circuit board plug connectors. This can be a socket or a (built-in) plug, wherein the corresponding opposite side is arranged on the connector board.

In the context of this disclosure, the output stage means the power semiconductor switches that belong to an AC voltage output of a power component. Since the gate driver circuits that are associated with the power semiconductor switches are locally separated from the power semiconductor switches in some embodiments of the invention, they are not counted as part of the output stage. The power component means the power semiconductor switches together with their respective gate driver circuits. The entirety of power components and controller is referred to as an inverter.

Some embodiments provide a particularly simple way of contacting the electronic components on the circuit boards, in which a plurality of cables between the controller and the circuit boards (at least one per azimuthally identical circuit board) is replaced by a single connector board per phase or even a connector board for a plurality of phases. If, for example, six circuit boards are connected in parallel for one phase in this type of electric motor, a connector board having a single cable is sufficient for controlling the contacting of all six circuit boards.

In some embodiments, a connector board is present for all plug connectors. For example, the plug connectors can be distributed azimuthally on the outer or inner edge of each annular structure. Then there is a connector board for each azimuthal position. These then form a shape that corresponds to an incomplete cylindrical shell.

In some embodiments, each connector board is connected in each case to all azimuthally identical plug connectors. Thus, if there are four circular or annular structures, then all of the circular or annular structures have a plug connector at the same azimuthal positions, and each connector board contacts all plug connectors that lie at an azimuthal position, i.e. form a line parallel to the central axis.

The connector boards may establish an indirect connection between the controller on the one hand and the output stages, i.e. the power semiconductor switches, on the circuit boards on the other hand. Indirectly means that the gate driver circuits for the power semiconductor switches are located in the middle of this connection, regardless of where they are physically arranged. The gate driver circuits can be arranged in various ways.

In some embodiments, the central axis of the circular or annular structures can correspond to the motor axis. In other words, this means that the center of each circular or annular structure lies on the motor axis, and that each of the circular or annular structures is arranged perpendicular to the motor axis. In this form of arrangement of the circular or annular structures, the field conductors or current conductors that continue them penetrate the circular or annular structures in a rotationally symmetrical manner when continued in a straight line. This results in a construction that can be readily modularized in which identical circuit boards can be used and in which the contacting of a respective field conductor is particularly simple.

In some embodiments, the field conductors or current conductors that continue them can even function as a mechanical carrier for the circuit boards, thereby further simplifying the construction.

In some embodiments, the circular or annular structures can have the same diameter. The spring contacts can thereby form a line running in the axial direction when attached to the circuit boards in the same manner. This enables an easy installation of the connector boards.

In some embodiments, the connector boards extend in the axial direction parallel to the motor axis. In this case, the extent refers to the orientation of the longest edge of the preferably rectangular connector boards.

In some embodiments, the number of connector boards can correspond to the number of field conductors. A connector board is therefore used per phase of the electric motor. This simplifies the construction of the connector board and reduces the wiring effort on the circuit board.

In some embodiments, a number of connector boards that is less than the number of field conductors can also be used. For example, the power components for two, three or more of the phases, that is to say the field conductor, can be arranged on a circuit board, and the circuit board can be configured in such a manner that a connection of the power components to a single connector board is achieved for control purposes. In this case, the number of connector boards corresponds to the number of field conductors or phases divided by the number of power components per circuit board.

This embodiment of the electric motor may be appropriate if a large number of field conductors, for example 48, 72 or even 120, is used. In such electric motors, it may be advantageous to reduce the number of circuit boards and connector boards per phase compared to the simpler variant having one connector board.

In some embodiments, the connector board can comprise gate driver circuits for the power components. This means that the gate driver circuits no longer require their own space on the circuit boards. For the power components, there is correspondingly more space on the circuit boards, which simplifies the design of the circuit boards. Furthermore, any waste heat from the gate driver circuits is also removed from the circuit boards, thus simplifying the cooling process.

In some embodiments, the connector board can comprise one or more local control chips that perform control tasks, for example a current measurement for a respective output stage. The local control chips are each allocated to and connected to one or more gate driver circuits.

In some embodiments, the gate driver circuits can be arranged on the circuit boards themselves together with the respective power semiconductor switches. This makes the connector boards easier to construct, since they only have to establish a connection between the controller and the circuit boards and thus the gate driver circuits, but can still contain additional circuits such as monitoring, control, amplifier/buffer circuits or communication interfaces. For this purpose, the connector boards can advantageously comprise a multiplexer.

In some embodiments, the gate driver circuits can also be arranged on their own driver boards. These may be plugged onto the circuit boards having the power semiconductor switches, wherein the arrangement of the circuit boards in this case is sandwich-like, i.e. the driver boards at least partially cover the circuit boards. In this case, the connector boards can be connected to the driver boards, to the output stage boards or to both, i.e. can have a connection to one or both of the circuit board types, via which signals are transmitted.

For this purpose, each phase that is controlled on a circuit board has a half-bridge that is constructed from two logic switches. In this case, a logic switch can comprise exactly one single power semiconductor switch. In order to allow higher currents to be switched, a logic switch can also comprise a plurality of power semiconductor switches, for example two, three, five or even more power semiconductor switches that are connected in parallel.

A gate driver circuit may be designed in such a manner that it drives the control terminals (for example gate terminals) of the two logic switches of the half-bridge, i.e. supplies current/voltage in such a manner that the switching actions required by the controller take place and the switches are switched on and off in a manner required by the controller.

If the logic switches of the half-bridge each comprise more than one parallel power semiconductor switch, then the gate driver circuit can be configured to actuate all of the power semiconductor switches. However, it is also possible to provide more than one gate driver circuit for the control. For example, the number of gate driver circuits can correspond exactly to the number of parallel power semiconductor switches. Thus, if the half-bridge comprises five high-side MOSFETs and five low-side MOSFETs, there can be up to ten gate driver circuits for this purpose. In this case, it is advantageous for reasons of space to arrange the gate driver circuits on the driver board or on the connector board.

In some embodiments, the connector board can comprise a multiplexer and be designed in such a manner that a control signal for a first power component, which is incoming from the controller on a first signal line, is conducted with the multiplexer to one of a plurality of second signal lines, which is connected to the first power component via a spring contact.

The multiplexer on the connector board ensures that the controller only has to be connected to the connector board using a single signal line, which simplifies the construction. This mya be advantageous if the connector board connects a plurality of power components on a single circuit board and a plurality of parallel connected power components to the controller, since in this case, without the multiplexer, a large number of parallel control lines would be required from the controller to the connector board. In this case, the individual signal line can be a direct electrical line or else a connection operating according to a communication standard, such as an optical connection, USB connection or a LAN connection.

In some embodiments, the connector board can comprise one or more screw connections to one or more of the circular or annular structures. Screw connections may prevent the connector board from becoming detached due to vibrations and other external circumstances.

In some embodiments, the connector board can be kinked, for example in the tangential direction. In this case, the connector board has the form of a flat pitched roof, the ridge of which extends axially. A more complex shape results if the connector board has a plurality of, e.g. parallel, kink lines. Such a connector board is suitable for contacting the plug connectors of a plurality of circuit boards that are arranged next to one another of a plurality of circular or annular structures, even if these plug connectors no longer lie in one plane and are oriented radially, i.e. are also not oriented parallel to one another, but are inclined relative to one another. While the unkinked connector boards result in a form that approximately forms an incomplete cylindrical shell, such kinked connector boards represent a combination of multiple of the unkinked connector boards and thus reduce the gaps in the cylindrical shell. A connector board having a kink may be expedient for contacting two circuit boards lying next to one another. A connector board having two kinks is expedient for contacting three circuit boards lying next to one another.

In some embodiments, the connector board can be a flexible circuit board. Flexible circuit boards can deform under mechanical stress. Conductor tracks and other electronic components on such circuit boards retain their electrical function. By using a flexible circuit board as a connector board, construction and installation are simplified, since the circular or annular structures now do not have to be at fixed distances from one another and can also be displaced with the connector boards in relation to one another in the installed state.

The electric motor can comprise second connector boards. Each second connector board is then plugged into a plurality of the connector boards. In turn, each of the connector boards is plugged into a single second connector board. In this case, the second connector boards each comprise a cable connection for the controller. This may eliminate the need for a cable connection from each of the connector boards to the controller, and the number of cable connections is reduced.

The second connector boards can be designed, for example, in the form of a ring sector or in the form of a circle sector. The center angle is selected such that at least two of the connector boards can be contacted. It is also possible for them to be designed as essentially rectangular but kinked boards.

The current conductors can be designed in such a manner that they lengthen the field conductors axially. The current conductors are designed similarly to the field conductors of the electric motor, but can have a different cross-sectional shape, for example. For example, the current conductors can have a round cross section, while the field conductors have an elongated rectangular cross section. In some embodiments, the current conductors can carry at least the same current as the field conductors. Current conductors and field conductors can be connected via shoes designed for this purpose, which ensure a mechanical and electrical connection.

In some embodiments, the circuit boards can be arranged on at least one cooling plate. In this case, the cooling plate can be covered on both sides with the circuit boards in order to achieve a high density of the electrical components. The cooling plate may be a metallic essentially circular or annular plate. In this case, the cooling plate can have heat pipes for cooling or cooling channels for throughflow with air or a fluid. The cooling plate can also be constructed from two annular plates arranged in parallel, which are screwed to one another in such a manner that a distance remains between them. Active ventilation can then be arranged in such a manner that air is drawn in between the plates.

The cooling plate can be arranged in such a manner that the field conductors or current conductors that are electrically connected to the field conductors are mechanically operatively connected to the cooling plate. For example, the current conductors or field conductors can be designed as a mechanical carrier for the cooling plate. For this purpose, the cooling plate may be arranged perpendicular to the axis of the electric machine. In this manner, the cooling plate having the circuit boards can be arranged in a space-saving manner at an axial end of the electric machine.

The circuit boards can be circular or in the form of a ring sector. Circuit boards having this shape can be assembled particularly well to form a circle or ring and thus optimally adapted to the shape of the electric machine can be arranged at one axial end of the machine, wherein a high degree of modularity is simultaneously achieved.

In some embodiments, the power components may be designed so as to generate an AC voltage having an amplitude of 200 V or less, in particular 100 V or less, in particular 50 V or less. This makes it possible for the components of the power electronics, in particular the power semiconductor switches, to be arranged at small distances in the millimeter range from one another, and thus a considerable number of power semiconductor switches can be arranged in a relatively small space. This makes it possible to provide high currents with not too large a space requirement and at the same time to generate a large number of phases, for example 6, 12, 24, 48, 72 or even 120 phases.

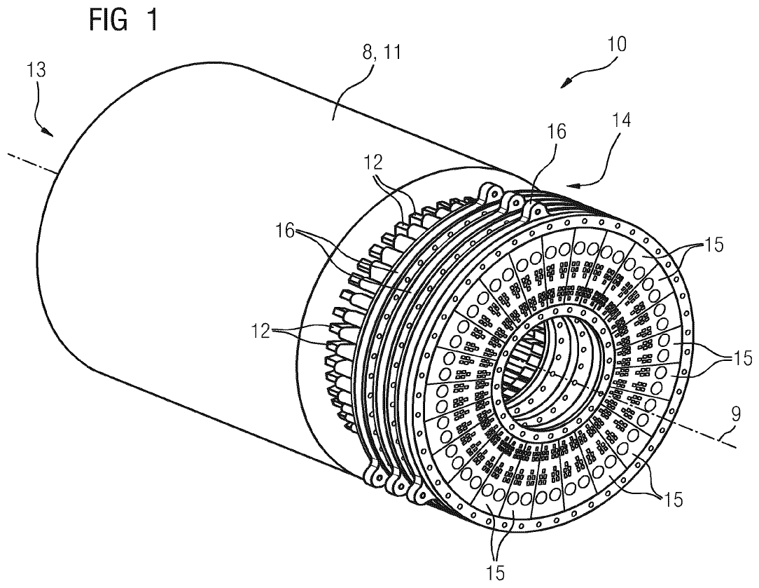

FIG. 1 illustrates an isometric view of an example electric motor 10 incorporating teachings of the present disclosure. The electric motor 10 comprises a stator 11 and a rotor, which is essentially arranged in the stator 11 and is not visible in FIG. 1. The rotor is connected in a rotationally fixed manner to a shaft, which is likewise not illustrated in FIG. 1. The rotor is set in rotation about an axis 9 by electromagnetic interaction of the rotor with a stator 11 that is supplied with current. In this case, the rotor is separated from the stator 11 by an air gap. In other embodiments, the electric motor 10 can also be an external rotor motor or bell armature motor.

The stator 11 comprises a plurality of rigid and straight conductor bars 12 as field conductors. These conductor bars 12 are connected to one another via a short-circuit ring on the remote end face 13 in FIG. 1. On the rear side 14 of the electric motor 10, the conductor bars 12 are fed individually by respective associated inverter modules. Since the conductor bars 12 are an electric motor 10 operated at low voltages, the inverter modules can be arranged relatively closely together on circuit boards 15 together with other components of the electronics (DC voltage converters, rectifiers). In this example, the circuit boards 15 are in the form of a ring sector and many individual circuit boards 15 together form an annular circuit board structure.

While the examples assume that the circuit boards 15 carry at least the power components of inverters, it is also possible for some of the circuit boards 15 to carry rectifiers and DC/DC converters.

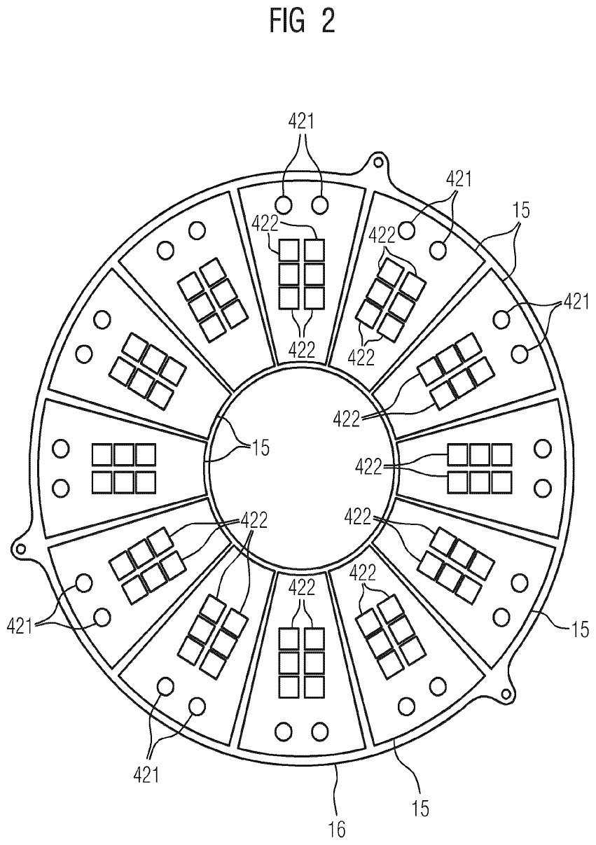

FIG. 2 illustrates a plan view of such a circuit board structure. The number of circuit boards illustrated in FIG. 2 is reduced and greatly simplified for better clarity compared to the illustration in FIG. 1. The specific number of such circuit boards 15 depends on the specific configuration of the electric motor 10, in particular the number of conductor bars 12. Each of the circuit boards 15 comprises a plurality of semiconductor switches 422. The semiconductor switches 422 together form power components of inverters, which provide an AC voltage for the conductor bars 12.

Furthermore, some or all of the circuit boards 15 can comprise driver circuits (not illustrated in the figures) and other electronic components such as capacitors. The semiconductor switches 422 are power semiconductors such as IGBTs, MOSFETs or JFETs, for example, and can additionally comprise diodes (not shown), depending on the circuitry. The semiconductor switches 422 are connected, for example, as half bridges. A capacitor (not shown) can, for example, represent an intermediate circuit capacitor of the half bridges. The semiconductor switches 422 of a circuit board 15 can be allocated to a single phase. In the case of an electric motor 10 having a large number of field conductors 12 and a corresponding number of phases, it is advantageous if a circuit board 15 carries the power components for multiple phases.

The circuit boards 15 further comprise contact points 421 to which the conductor bars 12 are connected. The circuit boards 15 are supported by disk-shaped cooling plates 16, wherein the cooling plates 16 can be covered with circuit boards 15 on both sides for better space utilization.

Since relatively high currents are required in the conductor bars in the electric motor 10, a plurality of power components are preferably connected in parallel to supply them with current. This can be achieved, for example, by ensuring that all the six circuit board structures on three cooling plates 16 illustrated in FIG. 1 are connected in the same way to the conductor bars 12 and thus are connected electrically in parallel. In this case, use is made of the fact that the conductor bars 12 or connecting elements 18 to the conductor bars 12 penetrate the cooling plates 16 and thus also the circuit boards 15 in the same way at the contact points or, in the case of the outermost cooling plate 16, at least make contact.

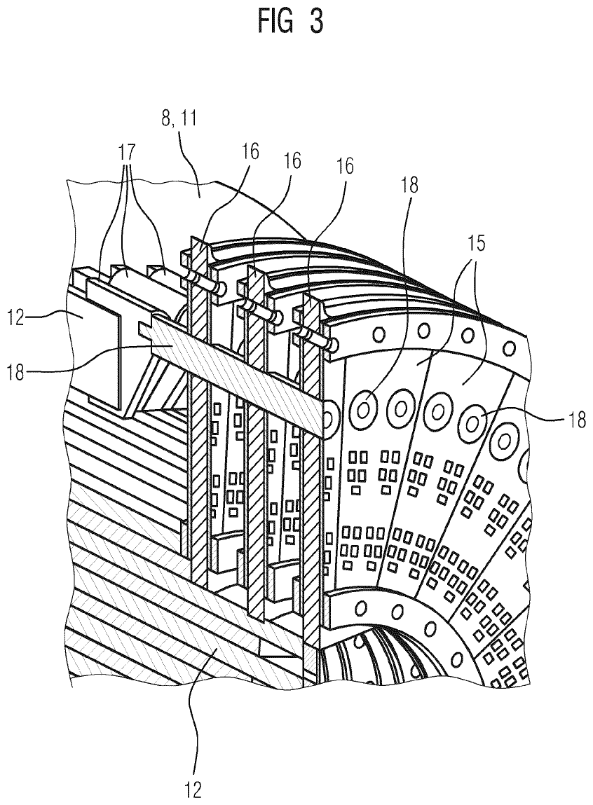

FIG. 3 illustrates a sectional view of the electric motor 10 in an oblique view. It can be seen here that the connecting elements 18 mechanically support and penetrate the three cooling plates 16. The connecting elements 18 are connected to the conductor bars 12 via shoes 17. The output stages, which are located on the circuit boards 15 in the regions in which one of the connecting elements 18 penetrates a cooling plate 16, are connected in parallel and together provide the current for the conductor bar 12. In the construction that is illustrated in FIG. 3, it can be seen that two of the connecting elements 18 each run through a circuit board 15. Thus, each of the circuit boards carries the output stages for two phases of the electric motor 10. In other variants for the electric motor 10, a single circuit board 15 can also carry only one phase or three or more phases, wherein the same number of connecting elements 18 pass through the circuit board 15.

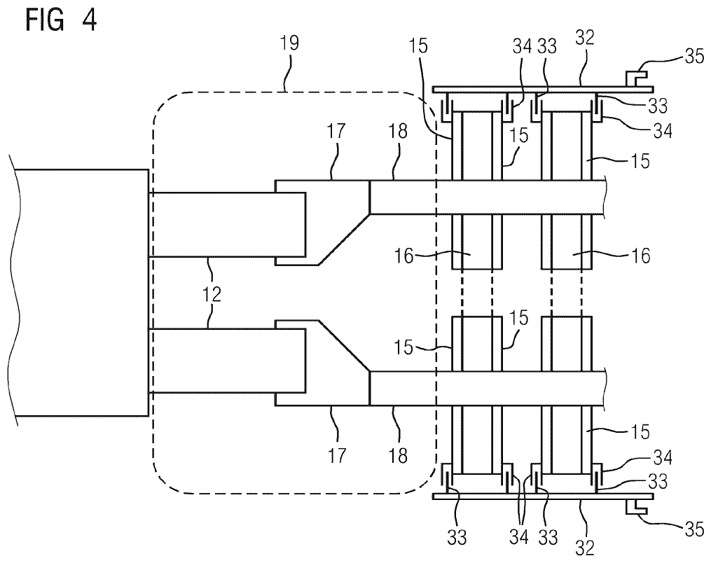

FIG. 4 illustrates a side view of a section of the electric motor 10. FIG. 4 illustrates eight circuit boards 15, which are arranged on two cooling plates 16. Furthermore, FIG. 4 illustrates two connector boards 32, which each connect four of the circuit boards 15. The connector boards 32 extend axially and are connected to sockets 34 of a respective circuit board 15 by means of spring contacts 33. Each of the connector boards 32 also has a socket 35 for a cable connection to a control board 31.

The arrangement in FIG. 4 corresponds to those in FIGS. 1 to 3. The sectional view of FIG. 4 therefore covers eight of the circuit boards 15 of the four ring structures that form the circuit boards 15. Likewise, the sectional image only captures the two connector boards 32, which are plugged into these eight circuit boards 15. In addition to the two connector boards 32 illustrated in FIG. 4, however, the electric motor 10 comprises further connector boards 32 (not illustrated). These are plugged onto the circuit boards 15 (not illustrated) and thus surround the illustrated construction and, viewed in a highly simplified geometric manner, form the shape of a loose cylindrical shell.

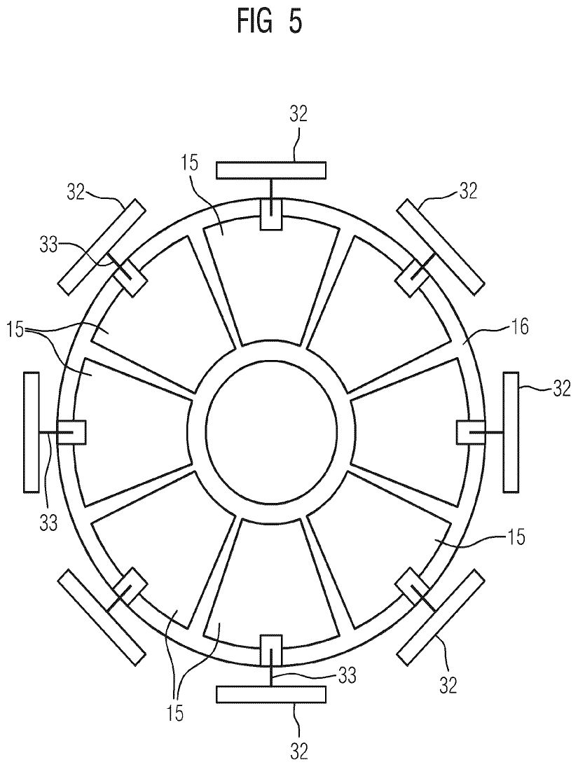

FIG. 5 illustrates the same construction in a greatly simplified front view. In FIG. 5 it is apparent that the circuit boards 15 form a ring structure. For each of the circuit boards 15, a connector board 32 is provided, which is connected to a respective circuit board 15 by means of spring contact 33 and socket 34. In accordance with FIG. 5, eight circuit boards 15 are arranged on the front side of the cooling plate 16, and when the cooling plates 16 are occupied on both sides and two cooling plates are used, as illustrated in FIG. 4, the electric motor 10 therefore comprises 32 circuit boards 15, which are connected to a control board 31 by means of eight connector boards 32.

In this case, the number of phases and thus current bars 12 does not necessarily play a role for the number of connector boards 32. FIG. 5 does not illustrate how many phases and thus how many current bars 12 the electric motor 10 has. One phase, two, three or more phases can be controlled per circuit board 15. The same number of current bars 12 or connector conductors 18 then leads into each of the circuit boards 15. However, the connector boards 32 are adapted to the number of phases to be driven, since a corresponding number of signal lines must be present.

The figures illustrate individual spring contacts 33 and sockets 34 in a simplified manner. In any case, however, this can also mean a plurality of actual signal lines. The sockets 34 can thus actually be socket connector strips and the spring contacts 33 can be corresponding plug connector strips.

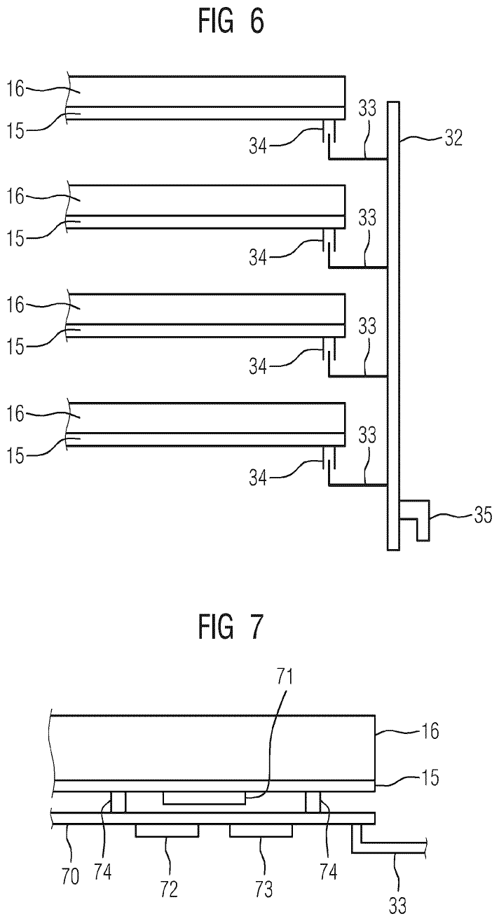

FIG. 6 shows an alternative embodiment of the spring contacts 33 and sockets 34, which is suitable for an electric motor 10 in which the cooling plates 16 are covered with circuit boards 15 on only one side. For the sake of clarity, FIG. 6 is greatly simplified. In this case, the sockets 34 can have an axial orientation in lieu of a radial orientation. In this example, the connector boards 32 are inserted by moving in the axial direction in lieu of the radial direction. Other orientations of the plug connectors, for example a tangential orientation, are also possible.

In some embodiments, the control board 31 is arranged concentrically with the cooling plates and axially displaced with respect to them and has the same outer radius as the circuit boards 15. The connector boards 32 are also plugged onto the control board 31 and establish signal connections via it. A cable connection between the connector boards 32 and the control board 31 is therefore omitted.

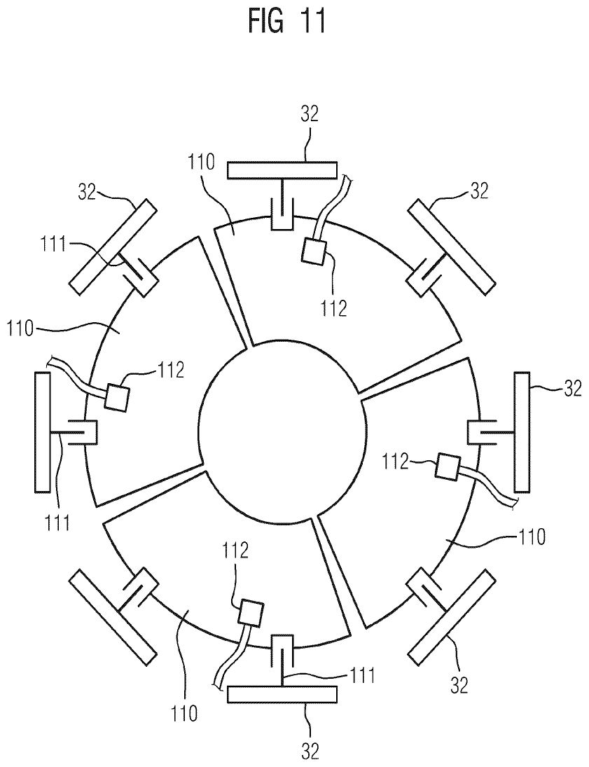

In some embodiments, e.g. as illustrated in FIG. 11, a plurality of the connector boards 32 are in each case plugged into a second connector board 110. For this purpose, the second connector board 110 can be designed, for example, in the form of a ring sector. It is expedient if, for this purpose, the connector boards 32 are designed in such a manner that they project beyond the cooling plate 16 furthest away from the stator/rotor block 8 and have a further plug connector 111 toward their end. This further plug connector 111 can be oriented axially or radially. Accordingly, the second connector boards 110 are then plugged into the end face or into the inner side or outer side of the connector boards 32.

The second connector boards 110 are designed in such a manner that they are plugged into a plurality of the connector boards 32. In the example of FIG. 11, the second connector boards 110 have a center angle of approximately 90°, i.e. are approximately quarter rings. In the case of large electric motors 10 having, for example, 72 phases or 120 phases, the radius of the rings can be in the meter range, and it can be expedient to plug in only two, three or four of the connector boards 32 here as well. In this case, the center angle for each of the second connector boards 110 is then, for example, only 9°, and three connector boards 32 are plugged into each of the second connector boards 110. In this case, the electric motor 10 then comprises 40 of the second connector boards 110.

The second connector boards 110 comprise a connection to the controller, for example as a LAN connection, USB connection or optical connection via a socket 112 on the second connector boards. The connection from the connector boards 32 to the controller, i.e. the socket 35 on the connector boards 32, can thus be omitted. Electrically, the second connector boards 110 thus combine the connector boards 32 once again and reduce the number of cable connections necessary for the controller.

An electric motor 10 can, for example, have three double-sided cooling plates 16 with twelve circuit boards 15 per side, i.e. 72 circuit boards 15. The circuit boards 15 are axially connected by twelve connector boards 32, which are plugged into six azimuthally identical circuit boards 15 each. Four second connector boards 110 in the shape of ring sectors are then plugged into in each case three of the connector boards 32. Each of the second connector boards 110 is thus connected directly, i.e. cable-free, to 18 circuit boards 15, and the number of cable connections to the controller drops to four, one per second connector board 110.

In addition to the elements that are illustrated in FIG. 11, the second connector boards 110 comprise at least one multiplexer 93 for distributing the signals and matching line connections between the socket 35, the multiplexer 93 and the plug connectors 111.

In all of the given examples, the connector boards 32 are plugged onto the circuit boards 15 radially on the outside. However, in some embodiments, it is also possible to plug in the connector boards 32 on the inside. In other words, the connector boards 32 are arranged on the inner edge, i.e. the edge belonging to the inner radius of the ring, on the annular structures that are formed by the circuit boards 15.

In addition to the possibility of plugging the connector boards 32 directly into those circuit boards 15 that carry the output stages, there is also a further embodiment that is illustrated in FIG. 7. The circuit board 15, which is arranged on a cooling plate 16, in this case carries an output stage of the inverter, which is illustrated in a simplified manner as a power semiconductor switch 71. A driver board 70 carries the gate driver circuit 72 and a local control chip 73. Plug connectors 74 transmit the signals between the circuit board 15 and the driver board 70. In this embodiment, the spring contact 33 is arranged on the driver board 70. In this embodiment, the connector board 32 is thus plugged into the driver board 70.

The embodiment options described above for the arrangement of the connector boards 32 on the circuit boards 15 can be combined with various embodiments for the connector boards 32 themselves, which are illustrated below with reference to examples.

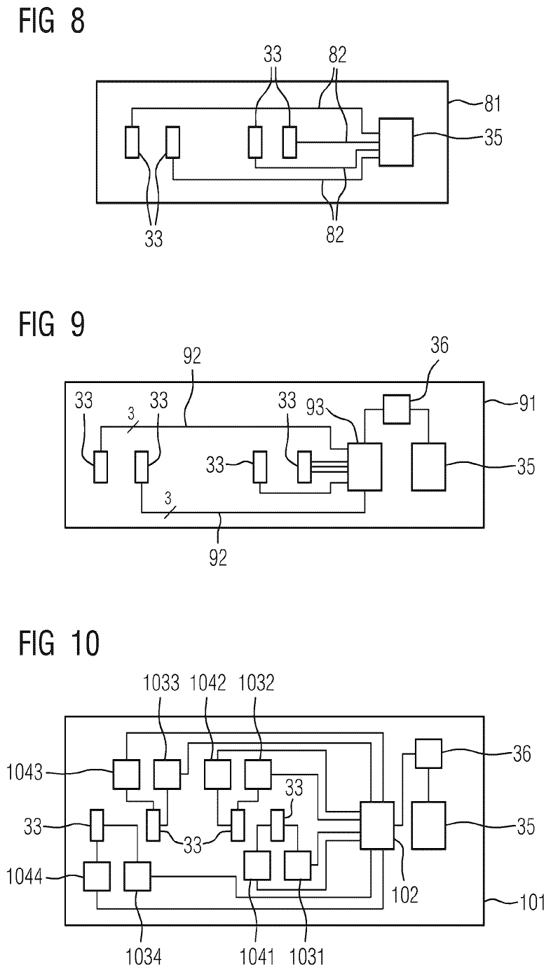

A first exemplary connector board 81 is illustrated in more detail in FIG. 8. The connector board 81 is rectangular, wherein the long side extends axially in the installed state as shown in the figures described above. In this first variant, the connector board 81 comprises only four signal lines 82.

These lead into the socket 35 at a first end. The socket 35 is provided for connection to the control board 31. It can lead the signal lines out in parallel, for example as a socket connector strip for a direct board connector or as a socket for a parallel interface cable. A further possibility is that the socket 35 is a USB or LAN (RJ45) socket. In this case, the connector board 81 also comprises electronic components (not shown in FIG. 8) for controlling the socket 35.

In this embodiment, the connector board 81 is therefore responsible for transporting the signals. This requires that the gate driver circuits for the power semiconductor switches are arranged together with them on the circuit boards 15 or are arranged on their own driver boards, which are plugged onto the circuit boards 15, for example, in such a manner that they partially cover them (boards stacked in a sandwich-like manner). The control signals for the gate driver circuits are passed through the connector board 81. Furthermore, it is assumed that four circuit boards 15, which are located axially at the same location, but are arranged on the front and rear sides of the two cooling plates 16, each drive only one phase and also require only one control signal for gate driver circuits.

In some embodiments, connector board 81 can also have other circuits such as monitoring, control, amplifier/buffer circuits or communication interfaces. A more complex connector board 91 is illustrated in FIG. 9. In this example, the socket 35 is a LAN connector having a control chip 36. The incoming control signals are divided into a plurality of signal lines 92 by a multiplexer 93. In FIG. 9, three signal lines 92 are illustrated per spring contact 33, but in real embodiments, there can be considerably more, for example 10 or even 30 signal lines 92, which lead to each of the plugged-in circuit boards 15.

In this embodiment of the connector board 91, the gate driver circuits for the power semiconductor switches are therefore located together with them on the circuit boards 15 or on their own driver boards. The control signals for the gate driver circuits are passed through the connector board 91.

It is also possible to arrange the gate driver circuits for the power semiconductor switches on the connector boards. An example connector board 101 as illustrated in FIG. 10 having gate driver circuits is illustrated in FIG. 10. The socket 35 is again a LAN connector having a control chip 36. The incoming control signals are divided into a plurality of signal lines by a multiplexer 93. The signal lines lead to a gate driver circuit 1031 . . . 1034 and a local control chip 1041 . . . 1044. In this case, the gate driver circuits 1031 . . . 1034 and the local control chips 1041 . . . 1044 are each allocated to a spring contact 33 and are connected to a circuit board 15 via them.

In principle, the connected circuit boards 15 can be controlled completely separately with the connector board 101. There therefore does not have to be a relationship between azimuthally identical circuit boards 15. In the electric motor 10 shown here, however, azimuthally identical circuit boards 15 always drive the same phase or the same phases. For the electric motor 10 shown here, it is therefore expedient to use the connector board 101 illustrated to control a single phase of the electric motor 10, which comprises a plurality of parallel-connected output stages on those circuit boards 15 that are connected via the connector board 101.

In cases where a circuit board 15 carries the output stages for multiple phases of the electric motor 10, it is expedient if a connector board in the form of the connector board 101 illustrated in FIG. 10 carries a corresponding number of the gate driver circuits 1031 . . . 1034 and local control chips 1041 . . . 1044 and transmits their signals to the circuit board 15 via the spring contact 33.

Since the connector board 101 in accordance with FIG. 10 already carries gate driver circuits, a combination with an embodiment in accordance with FIG. 7 is not expedient. However, it is possible to divide the necessary number of gate driver circuits between the connector board 101 and a driver board 70 in accordance with FIG. 7. Compared to the driver boards 70, which are arranged parallel to the circuit boards 15, the connector board 101 has the advantage that it enables the connection for control using a single cable connection for all azimuthally identical circuit boards 15.

### REFERENCE CHARACTERS

9 Motor axis
10 Electric motor
11 Stator
12 Conductor bars
13 End face
14 Rear face
15 Circuit board
16 Cooling plate
17 Shoe
18 Connecting element
32, 81, 91, 101 Connector board
33 Spring contact
34, 35 Socket
36 Control chip
70 Driver board
71 Power semiconductor chip
72 Gate driver circuit
73 Local control chip
82, 92 Signal line
93 Multiplexer
1031 . . . 1034 Gate driver circuit
1041 . . . 1044 Local control chip
110 Second connector board
421 Contact points
422 Semiconductor switch

What is claimed is:

1. An electric motor comprising:
a stator with a plurality of field conductors bars;
an inverter having one or more parallel power components for each of the field conductor bars and a controller to generate control signals for the one or more power components;
wherein
output stages of the inverter are arranged on a plurality of circuit boards;
the individual circuit boards are arranged to form at least two circular or annular structures arranged parallel and axially offset with respect to one another, so respective centers lie on a common central axis;
a respective plug connector arranged on each of the circuit boards to contact the output stages; and
a connector board plugged into plug connectors of circuit boards of different circular or annular structures that are azimuthally identical with respect to the central axis.

2. The electric motor as claimed in claim 1, wherein the axis of the circular or annular structures corresponds to an axis of the motor.

3. The electric motor as claimed in claim 1, wherein the at least two circular or annular structures have matching diameters.

4. The electric motor as claimed in claim 1, wherein the connector boards extend in an axial direction parallel to an axis of the motor.

5. The electric motor as claimed in claim 1, comprising one connector board for each field conductor.

6. The electric motor as claimed in claim 1, wherein the connector board comprises gate driver circuits for the power components.

7. The electric motor as claimed in claim 1, wherein the connector board comprises a multiplexer to conduct control signals incoming from the controller to one of a plurality of signal lines the control signals are fed to those power components to which they are addressed.

8. The electric motor as claimed in claim 1, wherein the connector board comprises one or more screw connections to one or more of the circular or annular structures.

9. The electric motor, as claimed in claim 1, wherein the connector board comprises a flexible circuit board.

10. The electric motor as claimed in claim 1, wherein current conductors lengthen the field conductors in an axial direction.

11. The electric motor as claimed in claim 1, wherein the circuit boards are arranged on at least one cooling plate.

12. The electric motor as claimed in claim 1, further comprising a cooling plate arranged so the field conductors or current conductors electrically connected to the field conductors are mechanically operatively connected to the cooling plate.

13. The electric motor as claimed in claim 1, wherein the circuit boards have a form of a ring sector.

14. The electric motor as claimed in claim 1, comprising 6 phases to control the field conductors.

15. The electric motor as claimed in claim 1, wherein the inverters generate an AC voltage having an amplitude of 200 V or less.
